(19) United States
(12) Patent Application Publication
(10) Pub. No.: US 2026/0245769 A1
(43) Pub. Date: Aug. 20, 2026

(54) ELECTRIC WIRE

(71) Applicant: PRIME POLYMER CO., LTD., Chuo-ku, Tokyo (JP)

(72) Inventors: Sumiaki FUJII, Chiba-shi, Chiba (JP); Yoshio YANAGISHITA, Kawasaki-shi, Kanagawa (JP)

(73) Assignee: PRIME POLYMER CO., LTD., Chuo-ku, Tokyo (JP)

(21) Appl. No.: 19/162,043

(22) PCT Filed: Mar. 8, 2024
(86) PCT No.: PCT/JP2024/009009

§ 371 Date: Sep. 3, 2025

(30) Foreign Application Priority Data
Mar. 10, 2023 (JP) 2023-037819

(51) Int. Cl. H01B 3/44; H01B 3/30; H01B 7/02; H01B 7/295

(52) U.S. Cl. CPC H01B 3/441; H01B 3/307; H01B 7/0275; H01B 7/295

(57) ABSTRACT

An electric wire having a coating layer that is excellent in an electric resistance property and mechanical strength and that has a satisfactory appearance is provided by using an insulating material that is excellent in extrusion processability containing a polymer containing ethylene as a main component.

The electric wire includes a conductor or a conductor-shielding layer that is coated with the insulating material containing a polymer containing ethylene as a main component, wherein, with regard to the polymer containing ethylene as a main component, a density is in a specific range; a melt flow rate (MFR) is in a specific range; a volume resistivity (Ω·cm) is in a specific range; a shear viscosity (Pa·s) is in a range that forms a specific flow curve; and a 50% failure time (F₅₀) in an environmental stress cracking resistance test (E.S.C.R. test) is in a specific range.

### TECHNICAL FIELD

The present invention relates to an electric wire coated with an insulating material containing a polymer containing ethylene as a main component, and, more specifically, to an electric wire coated with an insulating material that is excellent in an electric resistance property and mechanical strength by using an insulating material that is excellent in extrusion processability containing a polymer containing ethylene as a main component.

### BACKGROUND ART

Conventionally, polyethylene has been often used as an insulating material of an electric wire, and the excellent electric insulation property thereof has been appreciated. Applying polyethylene produced by using a metallocene catalyst to an insulating material has been proposed (Patent Literature 1 and Patent Literature 2).

However, an electric wire coating material that is more excellent in extrusion processability, electric resistance property, and mechanical strength has been in demand.

### CITATION LIST

### Patent Literature

Patent Literature 1: JP 2000-306432A
Patent Literature 2: JP 2006-312753A

### SUMMARY OF INVENTION

### Technical Problem

An object of the present invention is to solve the problems accompanying the conventional technology as described above, and to provide an electric wire having a coating layer that is excellent in an electric resistance property and mechanical strength and that has a satisfactory appearance by using an insulating material that is excellent in extrusion processability containing a polymer containing ethylene as a main component.

### Solution to Problem

That is, the outline of the present invention is as follows.

An electric wire comprising a conductor or a conductor-shielding layer that is coated with an insulating material containing a polymer containing ethylene as a main component, wherein the polymer containing ethylene as a main component satisfies the conditions (a) to (e) shown below.

(a) A density as measured in accordance with JIS K 6922 is 900 to 925 kg/m³.
(b) A melt flow rate (MFR) (temperature: 190° C.; load: 21.18 N) as measured in accordance with JIS K 6921 is 10 to 25 g/10 min.
(c) A volume resistivity (2 mm-thick press sheet) as measured in accordance with ASTM D257:2007 is 1.0×10¹⁶ Ω·cm or more.
(d) A shear viscosity at a shear rate of 12.2 (1/s) is 300 (Pa·s) or more and 8000 (Pa·s) or less, and a shear viscosity at a shear rate of 2432 (1/s) is 30 (Pa·s) or more and 220 (Pa·s) or less, as measured by using a capillary rheometer.

### Method for Measurement

Melt viscosity (flow curve) measurement
Apparatus: capillary rheometer “CAPILOGRAPH 1D” (Toyo Seiki Seisaku-sho, Ltd.)
Capillary: L=30 mm, D=1 mm, inflow angle=180°
Piston speed: 1, 2, 5, 10, 20, 50, 100, 200 mm/min
Measurement temperature: 190° C.
   (e) A 50% failure time (F₅₀) at an environmental stress cracking resistance (E.S.C.R. test; 3 mm-thick press sheet; test temperature: 65° C.) as measured in accordance with ASTM D1693 is 10 hours or more.

A crosslinking agent may or may not be compounded in the above-described insulating material. When the above-described insulating material is crosslinked by various methods, the surface of the coating layer formed of the insulating material becomes smooth, and the coating layer can be more excellent in, for example, mechanical strength, abrasion resistance, and heat resistance.

### Advantageous Effects of Invention

With the present invention, an electric wire having a coating layer that is formed of an insulating material excellent in extrusion processability containing a polymer containing ethylene as a main component and that is excellent in an electric resistance property and mechanical strength and has a satisfactory appearance can be provided. Further, taking advantage of the property thereof, a flame-retardant eco-friendly electric wire having a coating layer containing, particularly, inorganic flame retardant can be provided.

### DESCRIPTION OF EMBODIMENTS

The present invention relates to an electric wire in which an insulating material containing a polymer containing ethylene as a main component is extrusion-coated onto a conductor or a conductor-shielding layer such as a semi-conductive layer, and the configuration thereof will be described below.

Examples of the polymer containing ethylene as a main component used in the present invention include homopolymers of ethylene and ethylene/α-olefin copolymers, and one type thereof is used or two or more types thereof are used as necessary depending on the use of the electric wire.

### Polymer Containing Ethylene as Main Component

Among these, as the polymer containing ethylene as a main component, polymers containing 50% by weight or more, preferably 60% by weight or more of ethylene are preferred, and, among these, an ethylene/α-olefin copolymer is more preferred.

### <<Ethylene/α-Olefin Copolymer>>

The ethylene/α-olefin copolymer is formed of a copolymer of ethylene as a main component and an α-olefin having 3 to 20 carbon atoms, and examples of the α-olefin having 3 to 20 carbon atoms include propylene, 1-butene, 1-petene, 1-hexene, 4-methyl-1-pentene, 1-octene, 1-decene, and 1-dodecene.

In the ethylene/α-olefin copolymer, at least part of the monomers composing the copolymer may contain biomass-derived monomers (ethylene and α-olefin). The monomers composing the copolymer may be the biomass-derived monomers alone, or the monomers may contain both the biomass-derived monomers and fossil fuel-derived monomers. The biomass-derived monomer is formed of, as raw materials, any renewable natural raw materials and residues thereof derived from, for example, plants or animals including fungi, yeasts, algae, and bacteria and contains ¹⁴C isotopes as carbon in the proportion of approximately 10⁻¹², and the biomass carbon concentration (pMC) as measured in accordance with ASTM D6866 is approximately 100 (pMC). The biomass-derived monomer can be obtained by conventionally known methods. The monomers composing the ethylene/α-olefin copolymer according to the present invention preferably contain biomass-derived monomers from the viewpoint of reducing an environmental impact (mainly reducing greenhouse gas). Even when the raw material monomers contain a biomass-derived monomers, the molecular structure thereof except for 14C isotopes contained in a proportion of approximately 10⁻¹² to 10⁻¹⁴ is equivalent to that of an ethylene/α-olefin copolymer composed of fossil fuel-derived monomers, as long as the polymer production conditions such as the catalyst for polymerization, the polymerization process, and the polymerization temperature are equivalent. Therefore, the performance of them is not different from each other.

In the ethylene/α-olefin copolymer according to the present invention, at least part of the monomers composing the copolymer may contain chemical recycling-derived monomers (ethylene and α-olefin). The monomers composing the copolymer may contain chemical recycling-derived monomers alone or may contain chemical recycling-derived monomers and fossil fuel-derived monomers and/or biomass-derived monomers. The chemical recycling-derived monomer can be obtained by conventionally known methods. The monomers composing the ethylene/α-olefin copolymer according to the present invention preferably contain the chemical recycling-derived monomers from the viewpoint of reducing an environmental impact (mainly reducing waste). Even when the raw material monomers contain chemical recycling-derived monomers, since the chemical recycling-derived monomer is a monomer obtained by restoring a polymer such as waste plastic up to a monomer unit such as ethylene by, for example, depolymerization or thermal decomposition, or a monomer produced by using the above-described monomer as a raw material, the molecular structure thereof is equivalent to that of an ethylene/α-olefin copolymer composed of fossil fuel-derived monomers, as long as the polymer production conditions such as the catalyst for polymerization, the polymerization process, and the polymerization temperature are equivalent. Therefore, the performance of them is not different from each other.

The content of ethylene in the ethylene/α-olefin copolymer is usually 93 to 99 mol % and preferably 94 to 98 mol %, and the content of the α-olefin which is a comonomer is usually 1 to 7 mol % and preferably 2 to 6 mol %. The contents of the ethylene and the α-olefin can be measured by using ¹³C-NMR.

That is, the composition of the ethylene/α-olefin copolymer may be usually determined by measuring the 13C-NMR spectrum of the sample in which approximately 200 mg of the copolymer is homogeneously dissolved in 1 ml (milliliter) of hexachlorobutadiene in a test tube of φ 10 mm under the measurement conditions of the measurement temperature of 120° C., the measurement frequency of 25.05 MHz, the spectral width of 1500 Hz, the pulse repetition time of 4.2 sec, and the pulse width of 6 usec.

The polymer containing ethylene as a main component used in the present invention satisfies the conditions (a), (b), (c), (d), and (e) shown below.

(a)

The density as measured in accordance with JIS K 6922 is 900 to 925 kg/m³.

In this range, the density is preferably 902 to 920 kg/m³, more preferably 903 to 915 kg/m³, and further preferably 904 to 913 kg/m³.

If the density becomes higher than this range, the rigidity is likely to become excessively high to deteriorate the strength. If the density becomes lower than this range, the heat resistance is likely to be deteriorated.

(b)

The melt flow rate (MFR) (temperature: 190° C.; load: 21.18 N) as measured in accordance with JIS K 6921 is 10 to 25 g/10 min. In this range, the melt flow rate is preferably 10 to 20 g/10 min. The melt flow rate is further preferably 10 to 15 g/10 min.

If the MFR becomes higher than this range, the tensile strength is likely to be deteriorated, and, if the MFR becomes lower than this range, the high-speed formability is likely to be deteriorated.

(c)

The volume resistivity (2 mm-thick press sheet) is 1.0×10¹⁶ Ω·cm or more.

The lower limit of the volume resistivity is preferably 3.0×10¹⁶ Ω·cm or more. The lower limit of the volume resistivity is further preferably 5.0×10¹⁶ Ω·cm or more. The lower limit of the volume resistivity is even further preferably 8.0×10¹⁶ Ω·cm or more. The upper limit of the volume resistivity is not particularly limited in terms of the performance, but, since the polymer contains ethylene as a main component, the upper limit is practically 1.0×10¹⁹ Ω·cm or less.

The insulating property as the electric wire becomes higher when the volume resistivity becomes higher, and the insulating property is deteriorated when the volume resistivity becomes lower. It is known that the numerical value of the volume resistivity of a material is generally high where a conductor such as metal is not contained. Therefore, it is presumed that, even in an ethylene polymer in which polymerization is performed by using a catalyst containing a metal element and a small amount of the catalyst is remaining, the volume resistivity varies depending on the type of the metal of the catalyst.

(d)

The shear viscosity at a shear rate of 12.2 (1/s) is 300 (Pa·s) or more and 8000 (Pa·s) or less, and the shear viscosity at a shear rate of 2432 (1/s) is 30 (Pa·s) or more and 220 (Pa·s) or less, as measured by using a capillary rheometer.

With regard to this range, the preferred range of the shear viscosity at the shear rate of 12.2 (1/s) is 400 (Pa·s) or more and 5000 (Pa·s) or less, and the preferred range of the shear viscosity at the shear rate of 2432 (1/s) is 40 (Pa·s) or more and 200 (Pa·s) or less.

With regard to this range, the more preferred range of the shear viscosity at the shear rate of 12.2 (1/s) is 500 (Pa·s) or more and 4000 (Pa·s) or less, and the more preferred range of the shear viscosity at the shear rate of 2432 (1/s) is 50 (Pa·s) or more and 180 (Pa·s) or less.

With regard to this range, the further more preferred range of the shear viscosity at the shear rate of 12.2 (1/s) is 500 (Pa·s) or more and 4000 (Pa·s) or less, and the further more preferred range of the shear viscosity at the shear rate of 2432 (1/s) is 50 (Pa·s) or more and 120 (Pa·s) or less.

With regard to this range, the even more preferred range of the shear viscosity at the shear rate of 12.2 (1/s) is 500 (Pa·s) or more and 2000 (Pa·s) or less, and the even more preferred range of the shear viscosity at the shear rate of 2432 (1/s) is 60 (Pa·s) or more and 160 (Pa·s) or less.

With regard to this range, the particularly more preferred range of the shear viscosity at the shear rate of 12.2 (1/s) is 500 (Pa·s) or more and 2000 (Pa·s) or less, and the particularly more preferred range of the shear viscosity at the shear rate of 2432 (1/s) is 60 (Pa·s) or more and 100 (Pa·s) or less.

Where there are significant irregularities on the surface observed as, for example, variations of 0.5 mm or more depending on the place in the diameter of the resin strand discharged from the capillary rheometer, the measured numerical values are likely to have large variation, and, therefore, the data are preferably obtained by measurement in the state in which the surface of the resin strand is smooth.

In general, when the viscosity at a low shear rate becomes high, shearing stress is likely to be applied at the time of melt-kneading in an extruder, thereby promoting exchange of positions of materials such as fillers such as inorganic flame retardants, thereby enhancing the degree of dispersion. In materials having poor dispersibility of fillers and the resin, a part in which the fillers are locally concentrated occurs.

In the product, in the part having a higher filler concentration than the average filler concentration thereof, the resin is not sufficiently present, and, therefore, the tensile elongation is low and the tensile strength is also low, whereby the part is a part easily broken (weak part).

Where the coating layer of the present invention contains a filler, the satisfactory dispersibility thereof enhances the tensile strength of the coating layer, which is a formed product. When the viscosity at a high shear rate is low, the surface roughness of the surface of the coating layer at the time of formation of the coating layer is likely to be suppressed, whereby the forming speed can be increased without causing surface roughness. Therefore, it is difficult to achieve both enhancing the strength depending on melt-kneading with, for example, the filler, and preventing surface roughness of the coating layer at the time of high-speed forming by merely adjusting the MFR.

In the present invention, by focusing on the viscosity curve and selecting a specific range, surface roughness of the coating layer at the time of high-speed forming is suppressed, thereby allowing for formation at a relatively low resin pressure, whereby the processability is improved.

(e)

The 50% failure time (F₅₀) at an environmental stress cracking resistance (E.S.C.R. test; 3 mm-thick press sheet; test temperature: 65° C.) in accordance with ASTM D1693 is 10 hours or more. F₅₀ is more preferably 30 hours or more. F₅₀ is further preferably 100 hours or more. F₅₀ is even further preferably 200 hours or more. The upper limit is generally 1500 hours considering the practical measurement time, and is sometimes approximately 1000 hours.

When the numerical value of the 50% failure time (F₅₀) in the environmental stress cracking resistance (E. S.C.R. test) is small, the long-term durability is likely to be deteriorated. As the numerical value thereof becomes larger, the durability of the coating layer obtained from the ethylene/α-olefin copolymer is enhanced. An insulating material excellent in durability is used in the present invention, and, therefore, the insulating material of the present invention is suitable for a flame-retardant eco-friendly electric wire containing, particularly, inorganic flame retardant.

The numerical value of F₅₀ of the environmental stress cracking resistance (E.S.C.R. test) is adjusted by, for example, the molecular weight, the density, and the amount of compounding of the high-molecular-weight polymer of the ethylene/α-olefin copolymer, and the numerical value of F₅₀ is increased by, for example, increasing the molecular weight of the high-molecular-weight polymer or increasing the proportion thereof, and reducing the density thereof. With regard to polymers having a long-chain branched structure represented by high-pressure LDPE, which has high melt elongation and is easily processed, it is considered that the numerical value of F₅₀ of the environmental stress cracking resistance is smaller than that of linear polymers. In order to increase F₅₀, reducing the long-chain branched structure of the ethylene/α-olefin copolymer may also be performed. At the time of use as the material for an electric wire, where another polymer containing ethylene as a main component is further compounded in the copolymer, prescription adjustment such as reducing the amount of compounding of the polymer having a long-chain branched structure may be performed.

### Method for Producing Polymer Containing Ethylene as Main Component

The polymer containing ethylene as a main component can be produced by adjusting the polymerization conditions so that the polymer satisfies the above-described conditions (a) to (e) shown below by using a conventionally known catalyst system. For example, the density can be adjusted by changing the proportion of the copolymerization components of the polymer. The density becomes higher when the proportion of the copolymerizable components is reduced. The MFR can be adjusted by adjusting the average molecular weight of the polymer. As the average molecular weight becomes higher, the MFR becomes smaller.

As specified in (d), in order to adjust the range of the shear viscosity at a specific shear rate, there are, for example, methods in which a composition composed of two types of polymers having different average molecular weights is produced to obtain the polymer specified in (d), such as, in polymerization methods using conventional catalyst systems, a method in which the polymer is obtained by multi-stage polymerization such as two-stage polymerization, and a method in which the polymer is obtained by mixing polymers having different average molecular weights together. The polymer having a desired viscosity property is obtained by such moderate control of the molecular weight distribution.

### Method for Producing Polymer Containing Ethylene as Main Component

As a method for producing a polymer containing ethylene as a main component, particularly, an ethylene/α-olefin copolymer, there is a method in which the polymer is obtained by multi-stage polymerization such as two-stage polymerization by using a conventionally known catalyst system such as a single-site catalyst such as a metallocene catalyst.

### Method for Producing Ethylene/α-Olefin Copolymer

The ethylene/α-olefin copolymer having the above-described physical property can be preferably produced by feeding ethylene and an α-olefin having 3 to 20 carbon atoms into the polymerization system by using, for example, bis(n-propylcyclopentadienyl) zirconium dichloride, bis(n-butylcyclopentadienyl) zirconium dichloride, bis(1-methyl-3-n-propylcyclopentadienyl) zirconium dichloride, or bis(1-methyl-3-n-butylcyclopentadienyl) zirconium dichloride containing ligands having a cyclopentadienyl framework as a component (i), which is a transition metal compound of the polymerization catalyst.

For production of the ethylene/α-olefin copolymer, for example, a component (ii) (organoaluminum oxy compound), a carrier (iii), and, as necessary, a component (iv) (organoaluminum compound) are generally used in combination with the component (i).

Each component will be described below.

### Component (ii): Organoaluminum Oxy Compound

The organoaluminum oxy compound may be a conventionally known benzene-soluble organoaluminum oxy compound and may be a benzene-insoluble organoaluminum oxy compound such as those disclosed in JPH2-276807A. As the organoaluminum oxy compound, one type may be used alone or two or more types thereof may be used in combination. Specific examples thereof include methylaluminoxane.

Carrier (iii)

The carrier (iii) used is an inorganic or organic compound, and is a granular or particulate solid having a particle size of 10 to 300 μm, preferably 20 to 200 μm. Among these, as an inorganic carrier, porous oxides are preferred, and specific examples thereof include SiO₂, Al₂O₃, MgO, ZrO₂, TiO₂, Sb₂O₃, Cao, Zno, Bao, and ThO₂; or mixtures thereof such as SiO₂—MgO, SiO₂—Al₂O₃, SiO₂—TiO₂, SiO₂—V₂O₅, SiO₂—Cr₂O₃, SiO₂—TiO₂—MgO. Among these, porous oxides containing at least one component selected from the group consisting of SiO₂ and Al₂O₃ as a main component are preferred.

Such a carrier (iii) differs in properties depending on the type and the production method, and the carrier preferably used desirably has a specific surface area of 50 to 1000 m²/g, preferably 100 to 700 m²/g, and a pore volume of 0.3 to 2.5 cm²/g. The carrier (iii) may be, as necessary, fired at 100 to 1000° C., preferably 150 to 700° C., and then used.

Examples of another usable carrier (iii) include a granular or particulate solid of organic compounds having a particle size of 10 to 300 μm. Examples of the organic compounds include a (co) polymer containing, as a main component, an α-olefin having 2 to 14 carbon atoms such as ethylene, propylene, 1-butene, and 4-methyl-1-pentene; or a polymer or a copolymer containing, as a main component, vinyl cyclohexane or styrene.

### Component (iv): Organoaluminum Compound

Examples of the organoaluminum compound as the component (iv) which is added as necessary include compounds represented by the following general formula (I).

$${R}_{( n )}^{1} {AlX}_{( 3 - n )} \qquad ( I )$$

wherein R¹ represents a hydrocarbon group having 1 to 12 carbon atoms; X represents a halogen atom or a hydrogen atom; and n is 1 to 3.

R¹ is, for example, an alkyl group, a cycloalkyl group, or an aryl group, and specific examples thereof include a methyl group, an ethyl group, a n-propyl group, an isopropyl group, an isobutyl group, a pentyl group, a hexyl group, an octyl group, a cyclopentyl group, a cyclohexyl group, a phenyl group, or a tolyl group.

Specific Examples of such an organoaluminum compound include the following compounds.

Trialkylaluminum such as trimethylaluminum, triethylaluminum, triisopropylaluminum, triisobutylaluminum, trioctylaluminum, and tri-2-ethylhexylaluminum; alkenylaluminum such as isoprenylaluminum; and dialkylaluminumhalide such as dimethylaluminumchloride, diethylaluminumchloride, diisopropylaluminumchloride, diisobutylaluminumchloride, and dimethylaluminumbromide, for example.

As the organoaluminum compound, compounds represented by the following formula (II) may also be used.

$${R}_{( n )}^{1} {AlY}_{( 3 - n )} \qquad ( II )$$

wherein R¹ represents the hydrocarbon group same as R¹ as defined in the general formula (I); Y represents an —OR² group, an —OSi(R³)₃ group, an —OAl(R⁴)₂ group, an —N(R⁵)₂ group, an —Si(R⁶)₃ group, or an —N(R⁷)Al(R⁸)₂ group; n is 1 to 2; R², R³, R⁴, and R⁸ are each, for example, a methyl group, an ethyl group, an isopropyl group, an isobutyl group, a cyclohexyl group, or a phenyl group; R⁵ is, for example, hydrogen atom, a methyl group, an ethyl group, an isopropyl group, a phenyl group, or a trimethylsilyl group; and R⁶ and R⁷ are each, for example, a methyl group or an ethyl group.

As such an organoaluminum compound, specifically, compounds as described below are used.

Compounds represented by R¹₍ₙ₁₎Al(OR²)₍₃₋ₙ₎, for example, dimethylaluminum methoxide, diethylaluminum ethoxide, and diisobutylaluminum methoxide;
compounds represented by R¹₍ₙ₎Al(OSi(R³)₃)₍₃₋ₙ₎, for example, Et₂Al(OSiMe₃), (iso-Bu)₂Al(OSiMe₃), and (iso-Bu)₂Al(OSiEt₃);
compounds represented by R¹₍ₙ₎Al(OAl(R⁴)₂)₍₃₋ₙ₎, for example, Et₂AlOAlEt₂, and (iso-Bu)₂AlOAl(iso-Bu)₂;
compounds represented by R¹₍ₙ₎Al(N(R⁵)₂)₍₃₋ₙ₎, for example, Me₂AlNEt₂, Et₂AlNHMe, Me₂AlNHEt, Et₂AlN(SiMe₃)₂, and (iso-Bu)₂AlN(SiMe₃)₂;
compounds represented by R¹₍ₙ₎Al(Si(R⁶)₃)₍₃₋ₙ₎, for example, (iso-Bu)₂AlSiMe₃; and
compounds represented by R¹₍ₙ₎Al(N(R⁷)Al(R³)₂)₍₃₋ₙ₎, for example, Et₂AlN(Me)AlEt₂, and (iso-Bu)₂AlN(Et)Al(iso-Bu)₂.

Among the organoaluminum compounds represented by the general formulas (I) and (II), compounds represented by general formulas (R¹)₃Al, (R¹)ₙAl(OR²)₍₃₋ₙ₎, and (R¹)ₙAl(OAl(R⁴)₂)₍₃₋ₙ₎ are preferred, and compounds in which R¹ is an isoalkyl group and n=2 are particularly preferred.

### Method for Preparing Catalyst

The polymerization catalyst is prepared by, for example, bringing the component (i), the component (ii), the carrier (iii), and, as necessary, the component (iv) into contact with each other. The order of contact of each component here is arbitrarily selected, but it is preferred that the carrier (iii) and the component (ii) are mixed together to be brought into contact with each other and then the component (i) is mixed to be brought into contact with the resulting material, and then, as necessary, the component (iv) is mixed to be brought into contact with the resulting material.

The polymerization catalyst may be a prepolymerization catalyst obtained by allowing olefin such as ethylene to undergo prepolymerization in the presence of the component (i), the component (ii), the carrier (iii), and, as necessary, the component (iv).

The prepolymerization can be performed by introducing olefin such as ethylene into an inert hydrocarbon solvent in the presence of the component (i), the component (ii), the carrier (iii), and, as necessary, the component (iv).

The prepolymerization catalyst is prepared by, for example, the following method. That is, the carrier (iii) is suspended in an inert hydrocarbon. Next, the organoaluminum oxy compound (component (ii)) is added to this suspension liquid to be allowed to react for a predetermined period of time. Thereafter, the supernatant liquid is removed, and the resulting solid component is suspended again in the inert hydrocarbon. The transition metal compound (component (i)) is added to this system to be allowed to react for a predetermined period of time, and then the supernatant liquid is removed to obtain a solid catalyst component. Next, the solid catalyst component obtained in the above manner is added to the inert hydrocarbon containing the organoaluminum compound (component (iv)), and then olefin such as ethylene is introduced thereto, whereby the prepolymerization catalyst is obtained.

The prepolymerization may be performed either batchwise or continuously, and may be performed under reduced, normal, or increased pressure. In the prepolymerization, it is desirable to produce a prepolymer having an intrinsic viscosity [n] in the range of 0.2 to 7 (dl/g), preferably in the range of 0.5 to 5 (dl/g) as measured in decalin at at least 135° C. in the presence of hydrogen.

### Polymerization Method

The ethylene/α-olefin copolymer used in the present invention is obtained by copolymerizing ethylene with an α-olefin having 3 to 20 carbon atoms in the presence of the polymerization catalyst or the prepolymerization catalyst as described above.

Copolymerization of the ethylene with the α-olefin is performed in the gas phase or in the liquid phase in the slurry state. In the slurry polymerization, the solvent may be an inert hydrocarbon or the olefin itself.

Specific examples of the inert hydrocarbon solvent used in the slurry polymerization include aliphatic hydrocarbons such as butane, isobutane, pentane, hexane, octane, decane, dodecane, hexadecane, and octadecane; alicyclic hydrocarbons such as cyclopentane, methylcyclopentane, cyclohexane, and cyclooctane; aromatic hydrocarbons such as benzene, toluene, and xylene; and petroleum fractions such as gasoline, kerosene, and diesel fuel. Among these inert hydrocarbon media, for example, aliphatic hydrocarbons, alicyclic hydrocarbons, and petroleum fractions are preferred.

When the polymerization is performed by the slurry polymerization method or the gas phase polymerization method, it is desirable to use the olefin polymerization catalyst or the prepolymerization catalyst as described above in an amount of usually 10⁻⁸ to 10⁻³ gram atoms/liter, preferably 10⁻⁷ to 10⁻³ gram atoms/liter as the concentration of transition metal atoms in the polymerization reaction system.

In the polymerization, an organoaluminum oxy compound similar to the component (ii) and/or an organoaluminum compound similar to the component (iv) may be added. Here, the atomic ratio (Al/M) of the aluminum atom (Al) derived from the organoaluminum oxy compound and the organoaluminum compound to the transition metal atoms (M) derived from the transition metal compound (component (i)) is in the range of 5 to 300, preferably in the range of 10 to 200, and more preferably in the range of 15 to 150.

The polymerization temperature is usually in the range of −50 to 100° C. and preferably in the range of 0 to 90° C. when the slurry polymerization method is performed, and the polymerization temperature is usually in the range of 0 to 120° C. and preferably in the range of 20 to 100° C. when the gas phase polymerization method is performed.

The polymerization pressure is an increased pressure of usually normal pressure to 100 kg/cm², preferably 2 to 50 kg/cm², and the polymerization can be performed batchwise, semicontinuously or continuously, and can also be performed in multiple stages, for example, two stages.

With regard to the polymerization, it is desirable that the copolymerization is performed in two or more separate stages having different reaction conditions by using one or more polymerization vessels.

Various additives such as antioxidants, ultraviolet absorbing agents, lubricants, nucleating agents, antistatic agents, flame retardants, pigments, dyes, and inorganic or organic fillers are compounded in the polymer containing ethylene as a main component of the present invention as necessary.

### Insulating Material

The insulating material according to the present invention contains a polymer containing ethylene as a main component, and may be composed of the polymer containing ethylene as a main component alone, or may be a composition in which another olefin polymer is compounded. The polymer containing ethylene as a main component has an excellent extrusion property and can be an excellent insulating material, and can provide an electric wire having a coating layer that is excellent in an electric resistance property and mechanical strength and that has a satisfactory appearance, since the polymer satisfies the conditions (a) to (e) as described above.

The insulating material of the present invention may contain other polymers such as high-pressure low-density polyethylene, linear low-density polyethylene, high-density polyethylene, polypropylene, EVA, and modified polyethylene as necessary to an extent that the performance of the electric wire is not impaired. For example, where the high-pressure low-density polyethylene is contained, the compounding proportion is set to 3 to 40% by weight, more preferably 10 to 35% by weight.

Where an electric wire in which the strength is important is to be provided, a crosslinking agent may be compounded in the polymer containing ethylene as a main component, which is the insulating material. As the crosslinking agent, for example, peroxides and silane compounds are preferably used.

Examples of the peroxide include dicumyl peroxide, t-butyl cumyl peroxide, 1,3-bis-(t-butylperoxy-isopropyl)benzene, 2,5-dimethyl-2,5-di-(t-butylperoxy)-hexyne-3, 2,5-dimethyl-2,5-di(t-butylperoxy)-hexane, 1-(2-t-butylperoxyisopropyl)-4-isopropylbenzene, and 1-(2-t-butylperoxyisopropyl)-3-isopropylbenzene. These peroxides are compounded in an amount of 0.03 to 5 parts by weight, preferably 0.05 to 3 parts by weight based on 100 parts by weight of the insulating material.

Examples of the silane compound include vinyltrimethoxysilane and vinyltriethoxysilane. These silane compounds may be used in combination with the above-described peroxides, and are compounded in an amount of 0.3 to 5 parts by weight, preferably 0.5 to 3 parts by weight based on 100 parts by weight of the insulating material. When the silane compound is used, a crosslinking catalyst may be used in combination, and examples thereof include di-n-butyltin dilaurate and di-n-octyltin dilaurate.

Where the peroxide alone is compounded as a crosslinking agent, crosslinking reaction can be caused by heat, and where the silane compound is compounded, crosslinking reaction can be caused by water. The ethylene/α-olefin copolymer according to the present invention can also be crosslinked by irradiation with ionizing radiations such as an electron beam. The crosslinking method, the type and the amount of compounding of the crosslinking agent, and the crosslinking conditions may be selected so that the crosslinking degree is eventually 25% or more and preferably 40% or more.

Additives such as antioxidants, weathering stabilizers, light stabilizers, heat stabilizers, antistatic agents, lubricants, pigments, dyes, nucleating agents, plasticizers, hydrochloric acid absorbers, and flame retardants may be compounded in the insulating material as necessary to an extent that the object of the present invention is not impaired. The flame retardant compounded is not limited, and organic flame retardants containing halogenated resins may also be added. For example, inorganic flame retardants such as magnesium hydroxide and aluminum hydroxide, which are often used for products called flame-retardant eco-friendly electric wires, may be used. The content of the fillers such as the inorganic flame retardants is preferably 30% by weight or more and 80% by weight or less in the insulating material.

Where the insulating material is a polymer containing ethylene as a main component, if a crosslinking agent is compounded in the insulating material and crosslinking treatment is performed, the structure of the insulating material layer that coats the conductor or the conductor-shielding layer changes into a crosslinked structure, thereby enhancing the heat resistance and the heat cycle property.

### Method for Producing Electric Wire

The electric wire according to the present invention is produced by extrusion-coating an insulating material containing a polymer containing ethylene as a main component as described above onto a conductor or a conductor-shielding layer. Firstly, the insulating material is fed into a forming machine for extrusion-coating, and is melted and sent to the front of the extruder. Meanwhile, the electric wire is fed into a crosshead die provided at the tip of the extruder, and the melted insulating material is extruded around the electric wire, thereby continuously coating the electric wire. Here, the insulating material layer may be the outermost layer of the electric wire, or may be further coated with another resin or material outside the insulating material layer.

Where a polymer containing ethylene as a main component is a main component of the insulating material, the insulating material in an uncrosslinked state may be used for the electric wire, or a coating layer composed of a crosslinked insulating material may be used. Crosslinking treatment may be performed with an electron beam or an ultraviolet ray, but the insulating material in which a crosslinking agent is compounded is preferred. In this case, the crosslinking treatment is performed after forming the coating layer under the extrusion conditions as described above.

Where a peroxide is used as a crosslinking agent, the insulating material is crosslinked by heating the insulating material to a temperature equal to or higher than the decomposition temperature of the peroxide, and, as a method therefor, an electric wire including a crosslinked insulating material can be produced by, firstly producing a compound in advance by mixing a composition of a polymer containing ethylene as a main component and another olefin polymer with the peroxide in an extruder, and then performing coating by using the compound, followed by heating of the insulating material.

Where a silane compound is used as a crosslinking agent, the insulating material is crosslinked in the same manner by the action of water when the coated formed product is immersed in warm water or allowed to stand in the air. Here, the polymer containing ethylene as a main component or a composition of the polymer containing ethylene as a main component and another olefin polymer is firstly introduced into the hopper of an extruder, while the silane compound, the peroxide, and the crosslinking catalyst are continuously injected between the hopper and the extruder or into the barrel of the extruder, whereby the insulating material in which the silane compound is graft-copolymerized is produced in the extruder and coats the electric wire, and then the coated formed product is immersed in warm water or allowed to stand in the air, whereby an electric wire coated with a crosslinked insulating material can be produced.

Alternatively, as another method, the silane compound and the peroxide are firstly compounded with the ethylene/α-olefin copolymer or a composition of the ethylene/α-olefin copolymer and another ethylene polymer to produce a grafted product in advance and then the masterbatch of the crosslinking catalyst is added thereto, and the resulting material is introduced into an extruder to coat the electric wire. The coated formed product is then immersed in warm water or allowed to stand in the air, whereby the insulating material is crosslinked and a coated electric wire is produced.

The electric wire of the present invention can provide an electric wire having a coating layer that is formed of an insulating material excellent in extrusion processability containing a polymer containing ethylene as a main component and that is excellent in an electric resistance property and mechanical strength and has a satisfactory appearance.

### EXAMPLES

Next, the present invention will be described by way of Examples, but the present invention is not limited to the Examples.

The physical property, the capillary flow curve, and the evaluation were based on the following method.

Density (kg/m³)

The density was measured in accordance with JIS K 6922.

Melt Flow Rate (MFR) (g/10 Min; 190° C.)

The MFR was measured in accordance with JIS K 6921 at a temperature of 190° C. and a load of 21.18 N.

### Shear Viscosity (Pa·s)

The shear viscosity was measured by using a capillary rheometer under the following conditions.

### Method for Measurement

Melt viscosity (flow curve) measurement
Apparatus: capillary rheometer “CAPILOGRAPH 1D” (Toyo Seiki Seisaku-sho, Ltd.)
Capillary: L=30 mm, D=1 mm, inflow angle=180°
Piston speed: 1, 2, 5, 10, 20, 50, 100, 200 mm/min
Measurement temperature: 190° C.

### Kneading Performance of Filler at the Time of Compounding

If the shear viscosity at a shear rate of 12.2 (1/s) as measured by using the capillary rheometer is low, and the shearing stress is sufficiently transmitted to the resin and transfer of positions of the resin and the fillers such as inorganic flame retardants has sufficiently occurred inside the extruder, the “kneading performance of the filler at the time of compounding” is determined as “O”.

On the other hand, if the shear viscosity is excessively high, and the shear stress is not transmitted to the resin sufficiently, whereby transfer of positions of the resin and the fillers has not sufficiently occurred inside the extruder, the “kneading performance of the filler at the time of compounding” is determined as “X”.

### Surface Roughness at the Time of High-Speed Forming

If the shear viscosity at a shear rate of 2432 (1/s) as measured by using the capillary rheometer is sufficiently high and the smoothness of the surface of the electric wire is maintained, the “surface roughness at the time of high-speed forming” is determined as “O”. On the other hand, the shear viscosity is low and the smoothness of the surface of the electric wire is lost, the “surface roughness at the time of high-speed forming” is determined as “X”.

Where there are significant irregularities on the surface observed as, for example, variations of 0.5 mm or more depending on the place in the diameter of the resin strand discharged from the capillary rheometer, the measured numerical values have large variation, and, therefore, the determination is preferably based on the data obtained in the state in which the surface of the resin strand is smooth.

### Environmental Stress Cracking Resistance (E.S.C.R.) (Hr.)

The environmental stress cracking resistance was measured by the method in accordance with ASTM D1693. A 3 mm-thick press sheet was used.

### Long-Term Durability

If the endurance time of E.S.C.R as measured by the method in accordance with ASTM D1693 is sufficiently high and the weathering property is excellent, the “Long-term durability” is determined as “O”.

### Volume Resistivity (Ω·Cm)

The volume resistivity was measured by the method in accordance with ASTM D257:2007. A 2 mm-thick press sheet was used.

### Electric Insulation Property

If the numerical value obtained by measurement by the method in accordance with ASTM D257:2007 was sufficiently high and the insulating property was maintained, the “electric insulation property” was determined as “O”, and, if not, the “electric insulation property” was determined as “X”.

### Example 1

An ethylene/α-olefin copolymer (“Evolue SP15151” manufactured by Prime Polymer Co., Ltd.) was fed into a single screw extruder of φ 100 mm, and, meanwhile, a conductor of φ 16 mm was fed into the crosshead die and coating operation was performed continuously on the conductor to form a 2.5 mm-thick coating layer. The cylinder temperature and the die temperature of the extruder were both set to 200° C. to perform the forming. The physical property of the coating layer of the obtained electric wire was measured, and Table 1 shows the results.

### Comparative Examples 1 to 5

In each Comparative Example, measurement was performed in the same manner as in Example 1 except that the polyethylene resin shown below was used. Table 1 shows the results.

Comparative Example 1: ELITE 5220G manufactured by The Dow Chemical Company;
Density: 915 (kg/m³); MFR: 3.5 (g/10 min, 190° C.)

Comparative Example 2: COHERE S100 manufactured by Saudi Basic Industries Corporation;
Density: 915 (kg/m³); MFR: 1 (g/10 min, 190° C.)

Comparative Example 3: SUMIKATHENE G701 manufactured by Sumitomo Chemical Co., Ltd.;
Density: 919 (kg/m³); MFR: 6.9 (g/10 min, 190° C.)

Comparative Example 4: SUNTEC-LD M2270 manufactured by
Asahi Kasei Corporation;

Density: 923 (kg/m³); MFR: 7 (g/10 min, 190° C.)

Comparative Example 5: NEO-ZEX 25500J manufactured by Prime Polymer Co., Ltd.;
Density: 926 (kg/m³); MFR: 50 (g/10 min, 190° C.)

TABLE 1

| Item | | Unit | Example 1 |
|---|---|---|---|
| Basic physical | MFR(190° C.) | g/10 min | 14 |
| property | Density | kg/m³ | 911 |
| Capillary flow | Shear viscosity at shear rate | Pa · s | 568 |
| curve | of 12.2 (1/s) | | |
| | Kneading performance of | | ◯ |
| | filler at the time of | | |
| | compounding | | |
| | Shear viscosity at shear rate | Pa · s | 97 |
| | of 2432 (1/s) | | |
| | Surface roughness at the time | | ◯ |
| | of high-speed forming | | |
| Physical | Environmental stress cracking | Hr. | 600 or more |
| property of | resistance (E.S.C.R.) | | |
| press sheet | Long-term durability | | ◯ |
| | Volume resistivity | Ω · cm | 1.10 × 10¹⁷ |
| | Electric insulation property | | ◯ |

| Comparative | Comparative | Comparative | Comparative | Comparative |
|---|---|---|---|---|
| Example 1 | Example 2 | Example 3 | Example 4 | Example 5 |
| 3.5 | 1 | 6.9 | 6.9 | 50 |
| 915 | 903 | 919 | 922 | 926 |
| 2086 | 4257 | 568 | 1353 | 219 |
| ◯ | ◯ | ◯ | ◯ | X |
| 197 | 249 | 68 | 86 | 59 |
| — | X | ◯ | ◯ | ◯ |
| — | — | 3 | 3 | — |
| ◯ | — | X | X | — |
| 2.60 × 10¹⁵ | 9.60 × 10¹⁵ | 7.30 × 10¹⁶ | 8.90 × 10¹⁶ | — |
| X | X | ◯ | ◯ | — |

### INDUSTRIAL APPLICABILITY

The electric wire of the present invention is excellent in extrusion processability of the coating layer thereof, and is excellent in an electric resistance property and mechanical strength of the coating layer, and the electric wire of the present invention can be suitably used as an electric wire in a wide range of various fields.

1. An electric wire comprising a conductor or a conductor-shielding layer that is coated with an insulating material containing a polymer containing ethylene as a main component, wherein the polymer containing ethylene as a main component satisfies the conditions (a) to (e) shown below:
(a) a density as measured in accordance with JIS K 6922 is 900 to 925 kg/m³;
(b) a melt flow rate (MFR) (temperature: 190° C.; load: 21.18 N) as measured in accordance with JIS K 6921 is 10 to 25 g/10 min;
(c) a volume resistivity (2 mm-thick press sheet) as measured in accordance with ASTM D257:2007 is 1.0×10¹⁶ Ω·cm or more;
(d) a shear viscosity at a shear rate of 12.2 (1/s) is 300 (Pa·s) or more and 8000 (Pa·s) or less, and a shear viscosity at a shear rate of 2432 (1/s) is 30 (Pa·s) or more and 220 (Pa·s) or less, as measured by using a capillary rheometer,
Method for measurement:
Melt viscosity (flow curve) measurement:
Apparatus: capillary rheometer “CAPILOGRAPH 1D” (Toyo Seiki Seisaku-sho, Ltd.);
Capillary: L=30 mm, D=1 mm, inflow angle=180°;
Piston speed: 1, 2, 5, 10, 20, 50, 100, 200 mm/min; and
Measurement temperature: 190° C.; and
(e) a 50% failure time (F₅₀) at an environmental stress cracking resistance (E.S.C.R. test; 3 mm-thick press sheet;
test temperature: 65° C.) as measured in accordance with ASTM D1693 is 10 hours or more.

2. The electric wire according to claim 1, wherein (c) the volume resistivity (2 mm-thick press sheet) of the polymer containing ethylene as a main component as measured in accordance with ASTM D257:2007 is 1.0×10¹⁶ Ω·cm or more and 1.0×10¹⁹ Ω·cm or less.

3. The electric wire according to claim 1, wherein the polymer containing ethylene as a main component of the insulating material is a copolymer of ethylene and an α-olefin having 3 to 20 carbon atoms.

4. The electric wire according to claim 1, wherein a flame retardant is compounded in the insulating material.

5. The electric wire according to claim 1, wherein a crosslinking agent is compounded in the insulating material.
